(19) United States
(12) Patent Application Publication
(10) Pub. No.: US 2026/0357087 A1
(43) Pub. Date: Nov. 12, 2026

(54) FORMULATIONS FOR IMPROVED ADHESION IN ELECTROPHORETIC DISPLAYS AND METHODS OF MAKING AND USING THE SAME

(71) Applicant: E Ink Corporation, Billerica, MA (US)

(72) Inventors: Eugene BZOWEJ, Dunstable, MA (US); Vishanth UPPU, Marlborough, MA (US)

(21) Appl. No.: 19/667,230

(22) Filed: May 4, 2026

Related U.S. Application Data
(60) Provisional application No. 63/799,179, filed on May 2, 2025.

(51) Int. Cl. C09D 5/24; C09D 7/63; C09D 175/04; C09D 179/08; G02F 1/167; G02F 1/1681

(52) U.S. Cl. CPC C09D 5/24; C09D 7/63; C09D 175/04; C09D 179/08; G02F 1/167; G02F 1/1681

(57) ABSTRACT

Sealing compositions, and sealing films/electrophoretic media layers/electro-optic devices comprising the same are disclosed herein. Methods for preparing a sealing film and an electrophoretic media layer are also disclosed. The sealing compositions disclosed herein may lead to enhanced adhesion properties of the sealing films/electrophoretic media layers/electro-optic devices comprising the same.

### CROSS REFERENCE TO RELATED APPLICATIONS

This application claims the benefit of priority of U.S. Provisional Patent Application Ser. No. 63/799,179, filed May 2, 2025, the content of which is incorporated by reference in its entirety.

### BACKGROUND OF THE INVENTION

The electrophoretic display (EPD) is a non-emissive device based on the electrophoresis phenomenon of charged pigment particles suspended in a solvent. The display usually comprises two substrates with electrodes placed opposing each other. One of the electrodes is usually transparent. A suspension composed of a solvent and charged pigment particles is enclosed between the two plates. Typically, the suspension is encapsulated in microcapsules or within microcells, e.g., embossed microcells. When a voltage difference is imposed between the two electrodes, the pigment particles migrate between the electrodes such that a color of a pigment is visible at the viewing surface, according to the polarity and magnitude of the applied voltage. In some instances, a combination of pigments is viewable at the surface. Preferably, the electrophoretic display is bistable (multi-stable) in that it does not require energy to maintain the image.

In order to prevent sedimentation, partitions between the two electrodes are used to divide the space into smaller compartments. In a microcell electrophoretic display, the charged particles and the fluid are retained within a plurality of cavities formed within a carrier medium, typically a polymeric film. See, for example, U.S. Pat. Nos. 6,672,921 and 6,788,449. The microcells are also known in the literature as microcavities or microcups. The EPD comprises isolated cells formed from microcells of well-defined shape, size and aspect ratio and filled with charged pigment particles dispersed in a dielectric solvent or solvent mixture. The electrophoretic medium additionally includes free polymers and charge control agents.

A variety of color options have become commercially available for electrophoretic displays, including four-color displays (black, white, red, yellow; red, white, yellow, semi-transparent blue; cyan, yellow, magenta, white). Electrophoretic displays with four types of electrophoretic particles operate similar to the simple black and white displays EPDs when, for example, a single color matching the color of one of the particles is desired at the viewing surface. However, obtaining a broader color gamut, including mixed colors and process colors is more complicated and requires more exquisite control of the relative positions of the particles with respect to each other and the viewing surface. When done correctly, such four particle systems allow thousands of different colors to be produced at each pixel. More details of such systems are available in the following U.S. patents, all of which are incorporated by reference in their entireties: U.S. Pat. Nos. 9,361,836, 9,921,451, 10,276,109, 10,353,266, 10,467,984, and 10,593,272.

Top and edge sealing materials play an important role for the function and performance of electro-optic devices. In particular, in embossed microcell designs wherein an array of small containers is filled with an electrophoretic medium and sealed, the sealing layer is in direct contact with the electrophoretic medium thus, the sealing material must be insoluble to the non-polar fluid of the electrophoretic medium. Additionally, the sealing layer must be a good barrier to the non-polar fluid so that the non-polar fluid does not diffuse out form the microcells during the life of the device. Leaky sealing layers also lead to volume loss of the electrophoretic medium and sagging of the sealing layer, which results in optical non-uniformities or even electrical shorts.

Sealing materials for electro-optic devices must effectively protect sensitive components from environmental factors such as moisture, temperature fluctuations, and chemical exposure. They should exhibit minimal moisture absorption to prevent damage or performance degradation, and maintain thermal stability to handle varying temperatures without degradation. Chemical resistance is important to prevent interactions that could impact the device's functionality.

The choice of sealing material depends on the device's specific operating conditions and performance requirements. The electrically conductive properties of the sealing materials are also important because electrical potential is applied across the device and propagated via the sealing layer, among other components. Additionally, these materials should provide strong mechanical integrity to withstand stress, vibration, and pressure changes. Strong adhesion to various substrates ensures a durable and reliable seal.

Accordingly, there is a need for sealing layers that improve adhesive strength while not leading to degradation of the adhesion formulation previously observed in the prior art.

### BRIEF SUMMARY OF THE INVENTION

Disclosed herein are sealing compositions, and sealing films/electrophoretic media layers/electro-optic devices comprising the same. Methods for preparing a sealing film and an electrophoretic media layer are also disclosed.

One aspect of the present disclosure provides a sealing composition comprising a heterofunctional crosslinker and a sealant fluid comprising a matrix material. In some embodiments, the sealant fluid comprises a matrix material comprising one or more poly(vinyl alcohol) polymers and an aqueous crosslinkable polyurethane dispersion having carboxylic acid functional groups; optional conductive particles; and an optional second crosslinker capable of reacting with a carboxylic functional group; and where the heterofunctional crosslinker is capable of reacting with carboxylic acid functional group, a hydroxyl functional group, and a second heterofunctional crosslinker.

In some embodiments, the sealing composition comprises from about 1 to about 12 weight % of dry sealant fluid. In some embodiments, the heterofunctional crosslinker is an epoxysilane crosslinker and the second crosslinker is a carbodiimide crosslinker, such as a polycarbodiimide.

Another aspect of the present disclosure provides a sealing film prepared by crosslinking the sealing composition as disclosed herein to prepare a hybrid network, wherein the hybrid network comprises covalent bonds between heterofunctional crosslinkers and carboxylic acid functional groups of the matrix material, heterofunctional crosslinkers and hydroxyl functional groups of the matrix material, and covalent bonds between heterofunctional crosslinkers.

In some embodiments, the hybrid network comprises covalent bonds between second crosslinkers and carboxylic acid functional groups of the matrix material. In some embodiments, the heterobifunctional crosslinker or the second crosslinker covalently binds the sealing film to a substrate comprising surface carboxylic acid and/or hydroxyl functional groups.

Another aspect of the present disclosure provides an electrophoretic media layer comprising a film of microcells comprising partition walls and top-openings, an electrophoretic fluid comprising charged pigment particles dispersed in a solvent filling the microcells, and a top-sealing layer that encloses the electrophoretic fluid within the microcells, wherein the top-sealing layer is formed by crosslinking the sealing composition as disclosed herein.

Another aspect of the present disclosure provides an electro-optic device comprising a conductive layer; the electrophoretic media layer as disclosed herein, an adhesive layer, and an electrode.

In some embodiments, the film of microcells has surface carboxylic acid and hydroxyl functional groups and the top-sealing layer is covalently bound to the film of microcells.

Another aspect of the present disclosure provides a method of preparing a sealing film comprising crosslinking the sealing composition as disclosed herein.

In some embodiments, crosslinking the sealing composition comprises heating the sealing composition to between 40 °C to 90 °C.

Another aspect of the present disclosure provides a method for preparing an electrophoretic media layer comprising enclosing a film of microcells comprising partition walls and top-openings with the sealing composition as disclosed herein and crosslinking the sealing composition, wherein an electrophoretic fluid comprising charged pigment particles dispersed in a solvent fills the microcells.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 illustrates a cross-sectional view of a structure of a plurality of microcells before they are filled and sealed.

FIG. 2 illustrates a cross-sectional view of an example of an electro-optic device comprising a microcell structure.

FIG. 3 illustrates a cross-sectional view of an example of a front plane laminate assembly that can be used to form an electro-optic device comprising a microcell structure.

FIG. 4 illustrates a cross-sectional view of an example of a double release sheet that can be used to form an electro-optic device comprising a microcell structure.

FIG. 5A illustrates an exemplary equivalent circuit of a single pixel of an electro-optic display that uses an active matrix backplane with a storage capacitor.

FIG. 5B illustrates an exemplary equivalent circuit of a simplified electro-optic display of the invention, allowing driving in a row-column format.

FIG. 6 illustrates an exemplary electro-optic display that includes a display module. The electro-optic display also includes a processor, memory, one or more power supplies, and a controller. The electro-optic display may also include sensors to allow the electro-optic display to adjust operational parameters based upon the ambient environment, e.g., temperature and illumination.

FIG. 7 illustrates a schematic of crosslinking chemistry between polyurethane, carboxylic acid functionality, and substrate carboxylic acid functionality used in previous coatings.

FIG. 8 illustrates a schematic of crosslinking chemistry between an epoxy silane crosslinker (Coat-O-Sil 1770), polyurethane, polyvinyl alcohol, and microcell surface functionality.

FIG. 9 shows peel force data comparing formulations containing carbodiimide crosslinker with formulations containing a blend of carbodiimide crosslinker and epoxy silane crosslinker.

### DETAILED DESCRIPTION OF THE INVENTION

The disclosure is directed to a formulation for improved adhesion in an EPD. The disclosure is directed to an adhesive formulation where crosslinking blends are introduced into the adhesive formulation to provide siloxane networks that also serve as linkers to the substrate surfaces and matrix materials in the EPD.

Crosslinkers or crosslinker blends containing a plurality of unique functionality suitably matched to react with functionality present in matrix materials, as well as on the surface of substrate materials, are utilized to improve adhesion to substrates in the present disclosure. Further, crosslinkers may be capable of self-crosslinking, generating networks that also serves to link substrate surfaces and matrix materials.

The presently disclosed technology overcomes several issues in the prior art. Previous attempts to prepare adhesives did not utilize crosslinking of multiple binder materials within a matrix system. This limited the development of rheological properties that impact adhesive strength. Additionally, the high levels of particular crosslinkers used in the prior art often lead to degradation of adhesive properties. Crosslinker blends added to adhesive formulations can improve adhesive strength while not leading to degradation of the adhesion formulation previously observed in the prior art.

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electro-optic displays, microcell electrophoretic displays and encapsulated liquid crystal displays.

### Electro-Optic Displays

An electro-optic device, such as an electro-optic display, may comprise a layer of a solid electro-optic medium and at least two other layers disposed on opposed sides of the electro-optic medium, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous (light-transmissive) electrode and the other electrode layer is patterned into a matrix of pixel electrodes, each of which defines one pixel of the display.

The term “light transmissive” is used herein to mean that the layer thus designated transmits sufficient light to enable an observer, looking through that layer, to observe the change in display states of the electro-optic medium, which will normally be viewed through the light transmissive electrode layer and adjacent substrate (if present); in cases where the electro-optic medium displays a change in reflectivity at non-visible wavelengths, the term “light-transmissive” should of course be interpreted to refer to transmission of the relevant non-visible wavelengths.

Electro-optic displays may comprise an electrophoretic media layer including a film of microcells comprising partition walls and top-openings. The term “microcell” refers to the cup-like indentations created by microembossing or imagewise exposure. The term “cell”, in the context of the present disclosure, is intended to mean the single unit formed from a sealed microcell. An electrophoretic fluid comprising charged pigment particles dispersed in a solvent or solvent mixture fills the microcells, and a sealing layer encloses the electrophoretic fluid within the microcells. The electrophoretic media layer according to the various embodiments of the present disclosure may be incorporated in the electro-optic displays and assemblies disclosed herein.

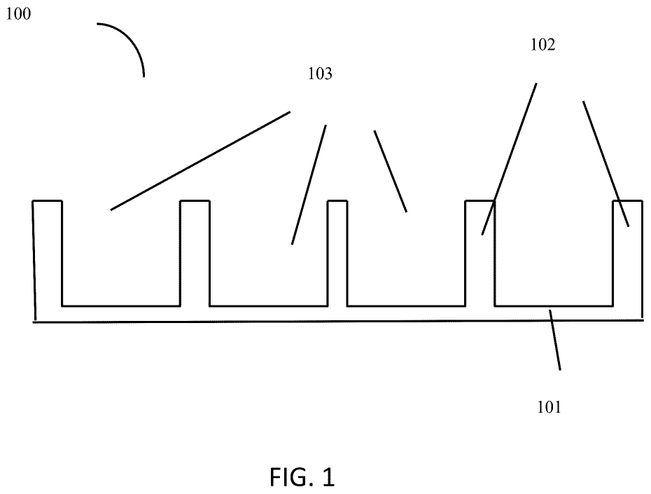

FIG. 1 illustrates a structure of a plurality of microcells 100 before they are filled and sealed. It is to be understood that FIG. 1 is a cross section of film of such microcells. Each microcell comprises a bottom 101, walls 102, and openings 103.

Microcells may be formed either in a batchwise process or in a continuous roll-to-roll process as disclosed in U.S. Pat. Nos. 6,933,098 and 7,470,386. Continuous roll-to-roll processing results in low cost, high throughput manufacturing technology for production of compartments for use in a variety of applications including benefit agent delivery and electro-optic displays. Microcell arrays suitable for use with the invention can be created with microembossing. For example, see U.S. Pat. No. 7,715,088, which is incorporated herein by reference in its entirety.

In general, the microcells can be of any shape, and their sizes and shapes may vary. The microcells may be of substantially uniform size and shape in one system. However, it is possible to have microcells of mixed shapes and sizes. The openings of the microcells may be round, square, rectangular, hexagonal or any other shape. The size of the partition area between the openings may also vary.

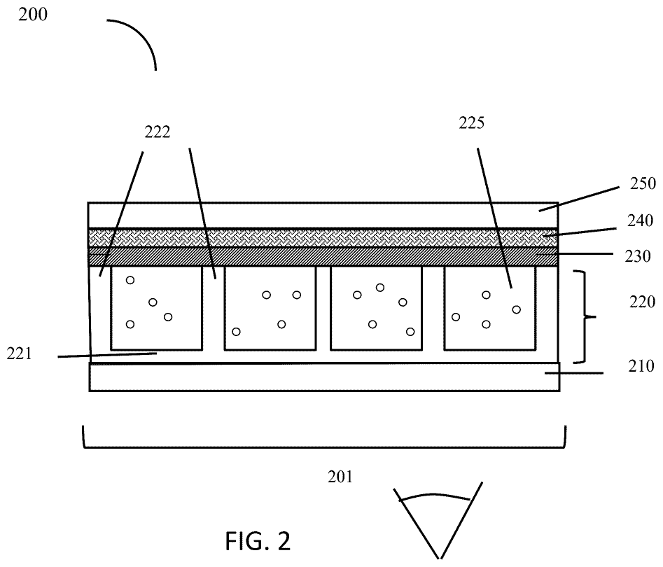

FIG. 2 illustrates an example of electro-optic device 200 comprising a microcell structure. This example of an electro-optic device 200 comprises first light-transmissive electrode layer 210 (for example ITO vapor-deposited on PET film), microcell layer 220, sealing layer 230, adhesive layer 240, and second electrode layer 250. The microcell layer comprises a plurality of microcells that are defined by bottom 221 and walls 222. Each of the plurality of microcells contains electrophoretic medium 225, which comprises charged particles in a fluid. The microcells are sealed with sealing layer 230, which spans the openings of the plurality of the microcells. Second electrode layer 250 is connected to sealing layer 230 with adhesive layer 240. The plurality of microcells, the sealing layer, and the electrophoretic medium 225, comprise the electro-optic material layer of electro-optic device 200. A source of an electric field (not shown) may connect first light-transmissive electrode layer 210 with second electrode layer 250. Application of an electric field across the electrophoretic material layer causes the charged particles to migrate through the electrophoretic medium, creating an image that can be observed by an observer looking from viewing side 20 of electro-optic device 200. An optional primer layer (not shown in FIG. 2) may be disposed between first light-transmissive electrode layer 210 and the plurality of microcells 230.

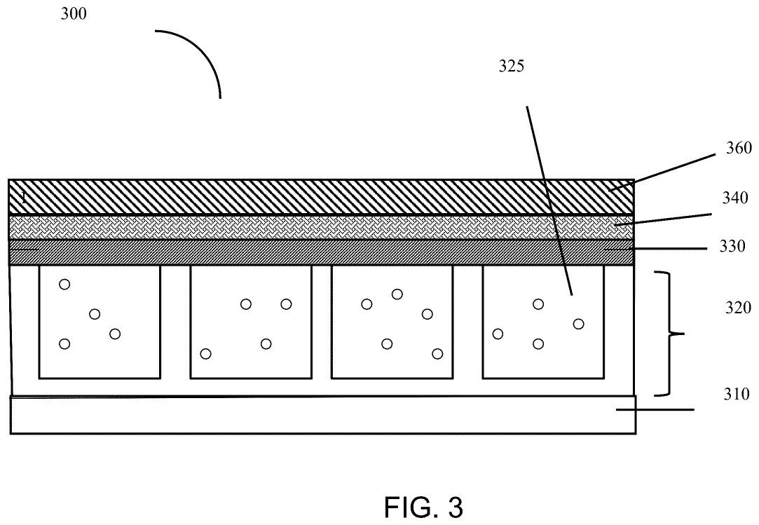

The example of an electro-optic device illustrated in FIG. 2 may be constructed from a front plane laminate 300, as is shown in FIG. 3. Front plane laminate (FPL) 300 comprises first light-transmissive electrode layer 310, a plurality of microcells 320, sealing layer 330, adhesive layer 340, and release sheet 360. Each of the plurality of microcells contains electrophoretic medium 325, which comprises charged particles in a non-polar fluid. The microcells are sealed with sealing layer 330, which spans the openings of the plurality of the microcells. Release sheet 360 is coupled to sealing layer 330 with adhesive layer 340. Removal of release sheet 360 exposes the surface of adhesive layer 340, which may be connected onto a second electrode layer to form an electro-optic device. An optional primer layer (not shown in FIG. 3) may be disposed between first light-transmissive electrode layer 310 and the plurality of microcells 330.

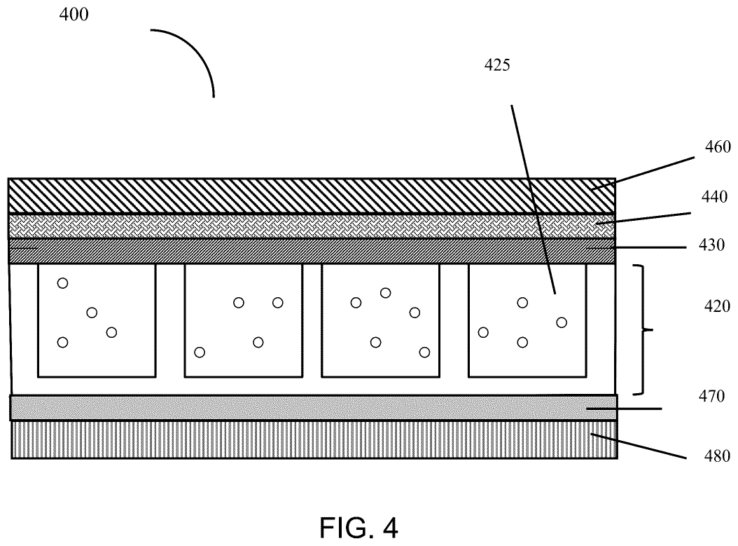

The example of an electro-optic device illustrated in FIG. 2 may be constructed from a double release sheet 400 that is shown in FIG. 4. Double release sheet 400 comprises first release sheet 480, first adhesive layer 470, a plurality of microcells 420, sealing layer 430, second adhesive layer 440, and second release sheet 460. Each of the plurality of microcells contains electrophoretic medium 425, which comprises charged particles in a non-polar fluid. The microcells are sealed with sealing layer 430, which spans the openings of the plurality of the microcells. First release sheet 480 is connected to the plurality of microcells 420 with first adhesive layer 470. The second release sheet is connected to sealing layer 430 with second adhesive layer 440. Removal of first release sheet 480 exposes the surface of first adhesive layer 470, which may be connected onto a first light-transmissive electrode layer. Removal of second release sheet 460 exposes the surface of second adhesive layer 440, which may be connected onto a second electrode layer to form an electro-optic device. An optional primer layer (not shown in FIG. 4) may be disposed between first adhesive layer 470 and the plurality of microcells 430.

A typical process of making sealed microcell structures for electrophoretic displays involves (a) fabricating, via microembossing, a polymeric sheet having a plurality of microcavities, wherein each microcavity has an opening, (b) filling the microcavities with an electrophoretic medium, which is a dispersion comprising charged pigment particles in a non-polar fluid, and (c) sealing the microcavities with an aqueous polymer composition, forming a sealing layer. The sealed microcavities, which contain electrophoretic medium, form the electro-optic material layer of the device. The electro-optic material layer is disposed between a front and a rear electrode. Application of an electric field across the electrophoretic medium via these electrodes causes pigment particles to migrate through the electrophoretic medium creating an image. In some embodiments, the electrophoretic display may be manufactured using previously disclosed methods, such as described in U.S. Pat. Nos. 6,930,818, 8,830,561, 6,672,921 and 6,788,449, which are incorporated by reference herein.

One aspect of the present disclosure provides an electro-optic device comprising a conductive layer; the electrophoretic media layer as described herein; an adhesive layer, and an electrode.

In some embodiments, the electro-optic device comprises a color EPD display. In some embodiments, the electro-optic device comprises a B&W EPD display.

### Electrophoretic Media Layer

Another aspect of the present disclosure provides an electrophoretic media layer. The term “electrophoretic medium”, in the context of the present disclosure, refers to the composition in the microcells. Electrophoretic medium disclosed herein may comprise an electrophoretic fluid and charged particles dispersed in a solvent that fills the microcells. The electrophoretic media layer may comprise a film of microcells comprising partition walls and top-openings, an electrophoretic fluid comprising charged pigment particles dispersed in a solvent filling the microcells, and a top-sealing layer that encloses the electrophoretic fluid within the microcells, wherein the top-sealing layer is formed by crosslinking the sealing composition as disclosed herein.

Another aspect of the present disclosure provides a method for preparing an electrophoretic media layer comprising enclosing a film of microcells comprising partition walls and top-openings with the sealing composition disclosed herein and crosslinking the sealing composition, wherein an electrophoretic fluid comprising charged pigment particles dispersed in a solvent fills the microcells.

The solvent within the microcells may be of low dielectric constant (e.g., less than 10 or less than 3). In some embodiments, the solvent includes aliphatic hydrocarbons such as heptane, octane, and petroleum distillates such as Isopar (Exxon Mobil) or Isane® (Total); terpenes such as limonene, e.g., 1-limonene; and/or aromatic hydrocarbons such as toluene. The index of refraction of the internal phase may be modified with the addition of index matching agents such as Cargille® index matching fluids available from Cargille-Sacher Laboratories Inc. (Cedar Grove, N.J.). In some embodiments, the solvent comprises an isoparaffinic hydrocarbon solvent.

The charged particles may vary in color, reflective or absorptive properties, charge density, and mobility in an electric field (measured as a zeta potential). A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention. The electrophoretic medium may comprise pigments having white, black, cyan, magenta, yellow, blue, green, red, and other colors.

The electrophoretic medium may contain two types of charged particles having different colors, a first type of charged particles having a first charge polarity, and a second type of charged particles that has a second charged polarity opposite to the first charged polarity. For example, the first type of charged particles may be black and the second type of charged particles may be white.

The electrophoretic medium may contain three types of charged particles all having different colors, a first type of charged particles having a first charge polarity, a second type of charged particles having a second charge polarity that is opposite to the first charge polarity, and a third type of charge particles having a third charge polarity that is the same as the first or the second charge polarity. For example, the first type of charged particles may be black, the second type of charged particles may be white, and the third type of charged particles may be selected from the group consisting of red, yellow, blue, cyan, magenta, green, and orange.

The electrophoretic medium may contain four types of charged particles all having different colors, a first type of charged particles having a first charge polarity, a second type of charged particles having the first charge polarity, a third type of charge particles having a second charge polarity opposite to the first charge polarity, and a fourth type of charged particles having the second charge polarity. The magnitude of the charge of the first type of particles may be higher than the magnitude of the charge of the second type of particles, and the magnitude of the charge of the third type of particles may be higher than the charge of the fourth type of particles. For example, the first type of charged particles may be cyan, the second type of charged particles may be magenta, the third type of particles may be yellow and the fourth type of charged particles may be white.

The electrophoretic medium may contain four types of charged particles all having different colors, a first type of charged particles having a first charge polarity, a second type of charged particles having the first charge polarity, a third type of charge particles having the first charge polarity, and a fourth type of charged particles having a second charge polarity that is opposite to the first charge polarity. The magnitude of the charges of the first, second, and third particles may be different from each other. The magnitude of the charge of the third type of particles may be higher than the magnitude of the charge of the first type of particles that may be higher than the magnitude of the charge of the second type of particles. For example, the first type of particles may be cyan, the second type of particles may be magenta, the third type of particles may be yellow, and the fourth type of particles may be white.

The electrophoretic medium may contain five types of charged particles all having different colors, a first type of charged particles having a first charge polarity, a second type of charged particles having the first charge polarity, a third type of particles having the first charge polarity, a fourth type of particles having a second charge polarity that is opposite to the first charge polarity, and a fifth type of particles having the second charge polarity. The magnitude of the first, second, and third charges may be different from each other. The magnitude of the charge of the third type of particles may be higher than the magnitude of the charge of the first type of particles that may be higher than the magnitude of the charge of the second type of particles. The charge of the fourth type of particles may have higher charge than the fifth type of charged particles. For one example, the first type of particles may be cyan, the second type of particles may be magenta, the third type of particles may be black, the fourth type of particles may be yellow, and the fifth type of particles may be white.

Additionally, the charged pigment particles may be functionalized with surface polymers to improve state stability. Such pigments are described in U.S. Patent Publication No. 2016/0085132, which is incorporated by reference in its entirety. The electrophoretic medium of the present invention may also contain one or more additives. For example, the electrophoretic medium of the present invention may comprise at least one charge control agent to control the charge on the various particles.

Typically, the electrophoretic medium composition may be filled into the microcells first and a water-soluble polymer composition is subsequently overcoated onto the filled microcells as a second step. The overcoating may be accomplished by a conventional coating and printing process, such as slot die, blanket coating, inkjet printing or other printing processes. Often the filling and sealing are done using a roll-to-roll process, whereby the microcells are filled and immediately sealed as the microcells progress through a coater. A sealing layer, in this approach, is formed in situ, by hardening the water-soluble polymer composition by solvent evaporation, radiation, heat, moisture, or an interfacial reaction. Interfacial polymerization followed by UV curing is beneficial to the sealing process. Intermixing between the electrophoretic medium composition and the sealing overcoat is significantly suppressed by the formation of a thin barrier layer at the interface by interfacial polymerization. The sealing is then completed by a post curing step, for example, by UV radiation or heating. The degree of intermixing may be further reduced when the specific gravity of the water-soluble polymer composition is lower than that of the electrophoretic medium composition. Volatile organic solvents may be used to adjust the viscosity and thickness of the sealing overcoat. Rheology of the water-soluble polymer composition may be adjusted for optimal sealability and coatability. When a volatile solvent is used in the overcoat, it is preferred that it is immiscible with the solvent in the electrophoretic medium composition.

In some embodiments, the sealing layer may comprise previously disclosed composition, such as described in U.S. application Ser. No. 17/590,835, which is incorporated by reference herein.

In some embodiments, the film of microcells has surface carboxylic acid and hydroxyl functional groups and the top-sealing layer is covalently bound to the film of microcells. The film of microcells described herein may be incorporated into the electro-optic device and electrophoretic media layer disclosed herein, or prepared according to the methods disclosed herein.

The coating quality of the microcells may be assessed quantitatively and/or qualitatively. Qualitative analysis may be conducted visually or spectroscopically. In some embodiments, coating quality may be assessed quantitatively through a peel test to identify % adhesion or % peeled of the sealing layer. In some embodiments, coating quality may be assessed visually or spectroscopically to identify the amount of bumps in the microcells and/or the coating defects, such as SDI, delamination areas, peeled areas, and/or cracked areas. In some embodiments, coating quality may be assessed quantitatively through a surface profile to identify the total SDI area.

In some embodiments, the sealing layer achieves at least 90%, at least 95%, at least 99%, or 100% adhesion with the filled microcells.

### Sealing Layer

The sealing layer plays a role for the function and performance of the device. Firstly, as the sealing layer is in contact with the electrophoretic medium and seals it inside the microcavities. The sealing layer should be insoluble in the non-polar fluid of the electrophoretic medium and should be a good barrier to the non-polar fluid so that the non-polar fluid does not diffuse or leak out form the microcells during the life of the device. Secondly, the sealing layer should not absorb a significant amount of moisture from the environment. That is, it should prevent environmental moisture from entering into the electrophoretic medium of the device; such moisture would negatively affect the electro-optic performance of the device. The ability to block out moisture is often categorized as WVTR (water vapor transmission rate); it quantifies the ability of a substance to block out water vapor at standard temperature and pressure. Typically, WVTR is measured in terms of is g H₂O/m²/day, however because a WVTR measurement is so sensitive to ambient temperature and humidity, substances are often only described qualitatively as having a “high” or “low” WVTR. Finally, the sealing layer of an electro-optic device should have good electrical properties, such as low electrical volume resistivity, because the driving electric field, which is applied across the electrophoretic medium for the operation of the display, must be transmitted through the sealing layer.

One important property of the sealing layer is its electrical volume resistivity. If the resistivity of the sealing layer is too high, a substantial voltage drop will occur within the sealing layer, requiring an increase in voltage across the electrodes to operate the device. On the other hand, if the sealing is too low, an undesirable cross talk between adjacent pixel electrodes is observed, reducing the image quality. Also, if the electrical volume resistivity is very low, the sealing layer will act as a dielectric layer (essentially turning the entire pixel into a capacitor) and the pixel will experience optical kickback (a change in optical state) as the capacitor discharges. In addition, because the volume resistivity typically increases rapidly with decreasing temperature, volume resistivity of the sealing layer that is too high may negatively affect the low temperature electro-optic performance of the display.

Another important property of the sealing layer, other than barrier property and volume resistivity, is its moisture absorption. If the sealing layer absorbs significant amounts of moisture from the environment over time, the electro-optic performance of the device becomes inferior.

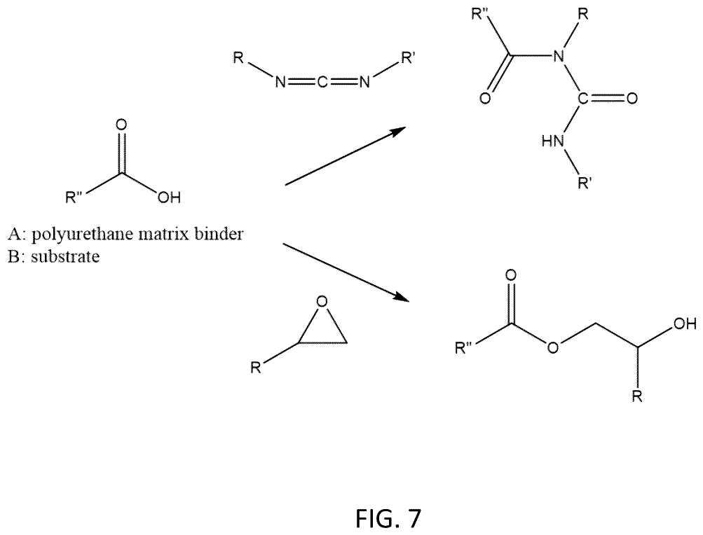

Adhesion of coating films to certain substrates is challenging owing to a number of often competing and offsetting effects such as interfacial surface compatibility, chemistry (functional group compatibility), surface roughness, material rheology, material component compatibility between the two phases, as well as specific coating dynamics associated with coating processes such as fluid wetting, drying and curing effects. For example, adhesion of sealant films to microcell substrates is challenging, owing in part to the fact that sealant film adhesion to microcells is limited to cell walls, which represents a small percentage of the total area of the cell surface. As another example, adhesion of certain previously reported adhesives to either electrode or microcell surfaces is limited, because adhesion of the matrix material (e.g., polyurethane) tends to vary inversely with crosslinker level. In other words, as the rheological properties are improved (modulus, crossover temperature) with increasing crosslinker concentration, adhesion to the aforementioned substrates can substantially deteriorate. Some current crosslinking technologies utilized in the microcell coating formulations, such as adhesives, binders and sealants, comprise either carbodiimide or epoxy functionality that crosslinks only the polyurethane component of matrix materials with itself and/or the substrate surface (FIG. 7). Crosslinking of the polyurethane to other matrix materials that do not contain an acid functionality, if present, does not occur.

The sealing compositions disclosed herein overcome the shortcomings of the prior arts by achieving improved cohesive strength of the matrix network containing crosslinkers or crosslinker blends disclosed herein; as well as enhanced adhesive strength with the microcell substrate.

One aspect of the present disclosure provides a sealing composition comprising a heterofunctional crosslinker and a sealant fluid. Heterofunctional crosslinker refers to a crosslinker that is capable of reacting with two or more different functional groups. The heterofunctional crosslinker allows for preparation of a hybrid network composed of two or more different components in a matrix material where the components can have different functional groups that are capable of reacting the heterofunctional crosslinker. For example, the matrix material may have carboxylic acid and hydroxyl functional groups on different components and the heterofunctional crosslinker is capable of reacting with both carboxylic acid and hydroxyl functional groups. The heterofunctional crosslinker may also allow for preparation of covalent bonds between one or more different components in a matrix material and a substrate where a functional group on the component of the matrix material and a functional group on the surface of the substrate may be different or the same. For example, a matrix material and substrate may have carboxylic acid and/or hydroxyl functional groups and the heterofunctional crosslinker is capable of reacting with both carboxylic acid and hydroxyl functional groups to form a covalent bond between a component of the matrix material and the substrate. The heterofunctional crosslinker may also be able to react with other heterofunctional crosslinkers. For example, the matrix material may have carboxylic acid and hydroxyl functional groups on different components and the heterofunctional crosslinker may have a silane functional group and the heterofunctional crosslinker is capable of reacting with both carboxylic acid and hydroxyl functional groups in the matrix material and silane functional groups on other heterofunctional crosslinkers. The sealant fluid may also comprise a second crosslinker. The second crosslinker may be capable of reacting with one or more types of functional groups. For example, the second crosslinker may be capable of reacting with one of the functional groups in the matrix material, such as carboxylic acid functional groups. In some embodiments, the sealant fluid comprises a matrix material comprising one or more poly(vinyl alcohol) polymers and an aqueous crosslinkable polyurethane dispersion having carboxylic acid functional groups; optionally conductive particles; and, further optionally, a second crosslinker capable of reacting with a carboxylic functional group. The heterofunctional crosslinker may be capable of reacting with a carboxylic acid functional group, a hydroxyl functional group, and a second heterofunctional crosslinker.

In some embodiments, the sealing composition comprises from about 1 weight % to about 30 weight %, about 1 weight % to about 25 weight %, about 1 weight % to about 20 weight %, about 1 weight % to about 15 weight %, about 1 weight % to about 12 weight %, or about 1 weight % to about 10 weight % of the sealant fluid. In some embodiments, the sealing composition comprises at least 3 weight %, at least 5 weight %, at least 10 weight %, at least 12 weight %, or at least 15 weight % of the sealant fluid. In some embodiments, the sealant fluid is dry.

Drying of the sealant fluid may be carried out under heating (e.g., in an oven) at least 50 °C, at least 70 °C, at least 80 °C, or at least 85 °C.

In some embodiments, the sealing composition comprises from about 1 weight % to about 20 weight %, about 1 weight % to about 15 weight %, about 3 weight % to about 10 weight %, or about 5 weight % to about 10 weight % of the heterofunctional crosslinker. In some embodiments, the sealing composition comprises at least 1 weight %, at least 2 weight %, at least 5 weight %, at least 7 weight %, or at least 10 weight % of the heterofunctional crosslinker.

In some embodiments, the heterofunctional crosslinker comprises an epoxysilane crosslinker. An epoxysilane crosslinker may comprise a compound of formula X—(CH₂)ₙ—Si(R¹)(R²)(R³). X may be an epoxycycloalkyl group, an epoxyalkyl group, or an epoxyalkoxyl group; R¹, R², and R³ may each independently be an alkoxy, hydroxy, or alkyl group provided that at least one of R¹, R², and R³ is alkoxy or hydroxy; and n may be an integer from 0-5.

In some embodiments, X is an epoxycyclohexyl, n is 2, and R¹, R², and R³ are ethoxyl. In some embodiments, the heterofunctional crosslinker comprises CoatOSil™ 1770 Silane, which contains β-(3,4-epoxycyclohexyl)ethyltriethoxysilane of formula

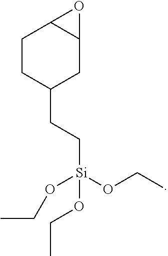

Alternative epoxysilane crosslinkers include the structures below (Structure 1 is duplicated above in better clarity). Additional epoxysilane crosslinkers might include 3-(2,3-Epoxypropoxy) propyltriethoxysilane, 3-(2,3-Epoxypropoxy) propylmethyldiethoxysilane, and 3-(2,3-Epoxypropoxy) propyltrimethoxysilane.

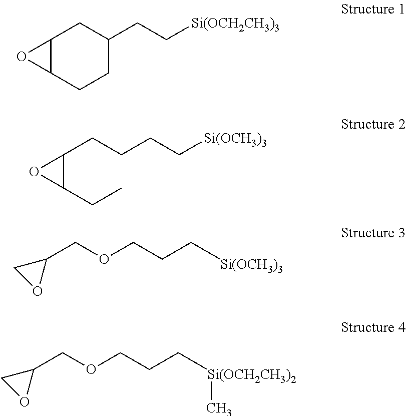

In some embodiments, the sealing composition comprises from about 1 weight % to about 20 weight %, about 1 weight % to about 15 weight %, about 3 weight % to about 10 weight %, or about 5 weight % to about 10 weight % of the second crosslinker. In some embodiments, the sealing composition comprises at least 1 weight %, at least 2 weight %, at least 5 weight %, at least 7 weight %, or at least 10 weight % of the second crosslinker.

In some embodiments, the second crosslinker comprises a carbodiimide crosslinker. In some embodiments, the carbodiimide crosslinker comprises a polycarbodiimide. Polycarbodiimides usually contain a plurality of carbodiimide, —N═C═N—, groups. Suitable polycarbodiimide linkers include, but are not limited to, CARBODILITE™ E-03A, CARBODILITE™ V-02-L2, CARBODILITE™ SV-02, CARBODILITE™ E-02, CARBODILITE™ V-02, CARBODILITE™ V-04, CARBODILITE™ V-10, and CARBODILITE™ E-05.

In some embodiments, the sealing composition comprises from about 20 weight % to about 60 weight %, about 25 weight % to about 55 weight %, about 30 weight % to about 50 weight % of the one or more poly(vinyl alcohol) polymers. In some embodiments, the sealing composition comprises at least 20 weight %, at least 25 weight %, at least 30 weight %, at least 35 weight %, or at least 45 weight % of the one or more poly(vinyl alcohol) polymers.

Suitable poly(vinyl alcohol) polymers include, but are not limited to, Exceval® RS-1717, Exceval® RS-2117, Exceval® RS-2817SB, Exceval® HR-3010, Gohsefimer™ Z-410, Selvol™ Ultiloc 5003, or Selvol™ Ultiloc 5103. See, also, U.S. Pat. Nos. 5,300,566 and 9,271,920, incorporated by reference. In some embodiments, the one or more poly(vinyl alcohol) polymers comprise a blend of Exceval® RS-1717 polyvinyl alcohol.

In some embodiments, the sealing composition comprises from about 5 weight % to about 50 weight %, about 10 weight % to about 45 weight %, about 10 weight % to about 40 weight %, or about 15 weight % to about 35 weight of the crosslinkable polyurethane dispersion. In some embodiments, the sealing composition comprises at least 5 weight %, at least 7 weight %, at least 10 weight %, at least 12 weight %, or at least 15 weight % of the crosslinkable polyurethane dispersion.

Polyurethanes are typically prepared via a polyadditional process involving a diisocyanate. Non-limiting examples of polyurethanes include polyether polyurethanes, polyester polyurethanes, polycarbonate polyurethanes, polyether polyureas, polyureas, polyester polyureas, polyester polyureas, polyisocyanates (e.g., polyurethanes comprising isocyanate bonds), and polycarbodiimides (e.g., polyurethanes comprising carbodiimide bonds). Generally, the polyurethane contains urethane groups. The polyurethanes utilized in the aqueous sealing compositions and sealing layers described herein may be prepared using methods known in the art. The polyurethanes of the sealing composition and sealing layer of the present disclosure may comprise polyester polyurethanes, polycarbonate polyurethanes, and mixtures thereof. The polyurethane of the sealing layer may have weight average molecular weight (MW) of from 1,000 to 2,000,000 Daltons, or from 10,000 to 300,000 Daltons, or from 15,000 to 200,000 Daltons.

In some embodiments, the crosslinkable polyurethane dispersion comprises Witcobond® W386-03 polyurethane dispersion.

Optionally, the sealing composition can include conductive particles. In some embodiments, the sealing composition comprises from about 0 weight % to about 30 weight %, about 0 weight % to about 15 weight %, about 1 weight % to about 15 weight %, about 1 weight % to about 10 weight %, about 1 weight % to about 5 weight %, about 2 weight % to about 5 weight %, or about 2 weight % to about 4 weight % of the conductive particles. In some embodiments, the sealing composition comprises at least 0.5 weight %, at least 1 weight %, or at least 2 weight % of the conductive particles.

The conductive particle may be selected from carbon black, graphene, graphite, and carbon nanotubes, metal oxide nanotubes, metal whiskers, metal flakes, and any combinations thereof. In some embodiments, the conductive particles comprises Raven 14 carbon black (Sigma Aldrich). Optionally, salts or conductive polymer additives, such as acrylics with charged functional groups, may be added.

In some embodiments, the sealing composition may comprise additional components, such as photoinitiators and/or thermal based catalysts to facilitate curing that are thermally or photochemically initiated.

Another aspect of the present disclosure provides a sealing film prepared by crosslinking the sealing composition disclosed herein to prepare a hybrid network. The hybrid network comprises covalent bonds between heterofunctional crosslinkers and carboxylic acid functional groups of the matrix material, heterofunctional crosslinkers and hydroxyl functional groups of the matrix material, and covalent bonds between heterofunctional crosslinkers.

In some embodiments, the hybrid network comprises covalent bonds between second crosslinkers and carboxylic acid functional groups of the matrix material.

In some embodiments, the heterobifunctional crosslinker or the second crosslinker covalently binds the sealing film to a substrate comprising surface carboxylic acid and/or hydroxyl functional groups.

In some embodiments, adhesion of the sealing film disclosed herein to microcell substrates is improved through the multiple crosslinking reactions, which provide more complete crosslinking of matrix binders and substrate surfaces.

In some embodiments, adhesion strength of the sealing film disclosed herein to a microcell substrate (e.g., microcell substrate surface) is determined using peel force data in a peel test. In some embodiments, the sealing film disclosed herein displays higher adhesion strength to microcell substrates, compared to a reference sealing film. In some embodiments, the reference sealing film does not contain the heterobifunctional crosslinker.

In some embodiments, the sealing film containing the sealing composition disclosed herein may achieve a maximum peel force of at least 100 gF, at least 110 gF, at least 120 gF, at least 130 gF, at least 140 gF, at least 150 gF, at least 160 gF, at least 170 gF, at least 180 gF, at least 190 gF, at least 200 gF, at least 210 gF, or at least 220 gF, as measured in a peel test. In some embodiments, the sealing film containing the sealing composition disclosed herein may achieve a maximum peel force of up to 500 gF as measured in a peel test.

Another aspect of the present disclosure provides a method of preparing a sealing film comprising crosslinking the sealing composition disclosed herein.

In some embodiments, crosslinking the sealing composition comprises heating the sealing composition. In some embodiments, the sealing composition is heated to at least 40 at least 50 °C, at least 70 °C, at least 80 °C, or at least 85 °C. Suitably, the sealing composition may be heated to a temperature between 40 °C to 90 °C or any range therebetween. The crosslinking may be accomplished alternatively or additionally with UV light exposure.

The sealing compositions and sealing films according to the various embodiments of the present disclosure may be incorporated into the electro-optic devices and electrophoretic media layers disclosed herein, or prepared according to the methods disclosed herein.

### Driving the Device

For the most part, electrophoretic media, such as described above, are designed to be driven with low voltage square waves, such as produced by a driver circuit using a thin-film-transistor backplane. Such driver circuits can be inexpensively mass-produced because they are very closely related to the driving circuitry and fabrication methods that are used to produce liquid crystal display panels, such as found in smart phones, laptop monitors, and televisions. Historically, even when electrophoretic media are driven directly via an isolated electrode (e.g., segmented electrode) the driving pulses are delivered as square waves, having an amplitude and a time width. See, for example, U.S. Pat. No. 7,012,600, incorporated by reference in its entirety. Typically, for an active matrix backplane including an array of pixel electrodes, each pixel electrode will receive a signal pulse (square wave) for a short period of time as the array of pixel electrodes are addressed in a line-by-line fashion. The period of time that it takes to update the entire array of pixels, and also the time between updates of an individual pixel electrode is known as a frame. The collection of voltage impulses required to change the display from a first display state to a second state is generally known as a waveform. A waveform typically includes at least three frames, e.g., as described in U.S. Pat. No. 11,620,959, which is incorporated by reference in its entirety.

Electro-optic displays typically have a backplane provided with a plurality of pixel electrodes each of which defines one pixel of the display. Each pixel electrode is typically disposed in a rectangular array of pixel electrodes and each pixel electrode is controlled with a thin-film transistor (TFT), and the TFTs are updated in a row-by-row fashion. Conventionally, a single common electrode extends over a large number of pixels, and normally the whole display is provided on the opposed side of the electro-optic medium. The single common electrode is coupled to the backplane via an isolated electrical connection, a.k.a., a “top plane connection.” The individual pixel electrodes may be driven directly (i.e., a separate conductor may be provided to each pixel electrode) or the pixel electrodes may be driven in an active matrix manner which will be familiar to those skilled in backplane technology. Since adjacent pixel electrodes will often be at different voltages, they must be separated by inter-pixel gaps of finite width in order to avoid electrical shorting between electrodes. Although at first glance it might appear that the electro-optic medium overlying these gaps would not switch when drive voltages are applied to the pixel electrodes (and indeed, this is often the case with some non-bistable electro-optic media, such as liquid crystals, where a black mask is typically provided to hide these non-switching gaps), in the case of many bistable electro-optic media the medium overlying the gap does switch because of a phenomenon known as “blooming.”

Blooming refers to the tendency for application of a drive voltage to a pixel electrode to cause a change in the optical state of the electro-optic medium over an area larger than the physical size of the pixel electrode. An area of blooming is not a uniform color, but is typically a transition zone where, as one moves across the area of blooming, the color of the medium transitions from the desired color to another shade or color, for example a desired white pixel may include various shades of gray along the edges, a.k.a., “edge ghosting”. Furthermore, depending upon the type of display, i.e., black/white, color, black/white with color filter, the results of the edge ghosting can range from annoying to debilitating. In some cases, asymmetric blooming may contribute to edge ghosting. The severity of ghosting may increase with increasing temperature. Displays that have a limited amount of blooming at room-temperature (about 20 °C) may have more severe blooming at temperatures above 30 °C, 40 °C, 50 °C, or 60 °C. Severe blooming at such temperatures may render the display unsuitable for use at those temperatures.

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays. While the bistable nature of electrophoretic displays allows for massive power savings over traditional “always on” displays such as LCD and LED, the bistability can lead to image retention between updates, e.g., “ghosts” or “image sticking”.

The term impulse, when used to refer to driving an electro-optic display, is used herein to refer to the integral of the applied voltage with respect to time during the period in which the display is driven. The term waveform, when used to refer to driving an electro-optic display is used to describe a series or pattern of voltages provided to an electro-optic medium over a given time period (seconds, frames, etc.) to produce a desired optical effect in the electro-optic medium.

Waveforms for driving four-particle electrophoretic media have been described previously. Waveforms for driving color electro-optic displays having four particles are described in U.S. Pat. Nos. 9,921,451, 9,812,073, and 11,640,803, all of which are incorporated by reference herein. Most commercial electro-optic displays use amorphous silicon based thin-film transistors (TFTs) in the construction of active matrix backplanes (560) because of the wider availability of fabrication facilities and the costs of the various starting materials. Amorphous silicon thin-film transistors may become unstable when supplied gate voltages that would allow switching of voltages higher than about +/−15V, e.g., +/−24V. Accordingly, as described in previous patents/applications on such systems, improved performance is achieved by additionally changing the bias of the top light-transmissive electrode with respect to the bias on the backplane pixel electrodes, a technique known as top-plane switching. Thus, if a voltage of +30V (relative to the backplane) is needed, the top plane may be switched to −15V while the appropriate backplane pixel is switched to +15V. Methods for driving a four-particle electrophoretic system with top-plane switching are described in greater detail in, for example, U.S. Pat. No. 9,921,451. In alternative embodiments, metal oxide semiconductors may be incorporated into thin film transistors for active matrix backplanes (560), including IGZO, i.e., as described in U.S. Pat. No. 11,776,496, which is incorporated by reference in its entirety.

In some embodiments, the electro-optic display may include only a first light-transmissive electrode, an electrophoretic medium, and a second (rear) electrode, which may also be light-transmissive. However, to produce a high-resolution display, e.g., as shown in FIG. 2, each pixel must be addressable without interference from adjacent pixels so that an image file is faithfully reproduced in the display. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are connected to a row driver, which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column electrodes are connected to column drivers, which place upon the various column electrodes voltages selected to drive the pixels in the selected row to their desired optical states. (The aforementioned voltages are relative to a common front electrode which is conventionally provided on the opposed side of the electro-optic medium from the non-linear array and extends across the whole display.)

After a pre-selected interval known as the “line address time” the selected row is deselected, the next row is selected, and the voltages on the column drivers are changed so that the next line of the display is written. This process is repeated so that the entire display is written in a row-by-row manner. The entire process is coordinated with a clock circuit. The time between addressing a pixel for the nth time and the following addressing, n+1, is known as a “frame.” Thus, a display that is updated at 60 Hz has frames that are 16 msec. “Frames” are not limited to use with an active matrix backplane, however. The driving frames described herein can also be used to refer to a unit of time between updates of, e.g., a singular backplane. While it is possible to drive electro-optic media with an analog voltage signal, such as produced by a power supply and a potentiometer, the use of a digital controller discretizes the waveform into blocks that are typically on the order of 10 ms, however shorter or longer framewidths are possible.

In a conventional electro-optic display using an active matrix backplane, each pixel electrode has associated therewith a capacitor electrode (storage capacitor) such that the pixel electrode and the capacitor electrode form a capacitor; see, for example, International Patent Publication WO 01/07961. In some embodiments, N-type semiconductor (e.g., amorphous silicon) may be used to from the transistors and the “select” and “non-select” voltages applied to the gate electrodes can be positive and negative, respectively.

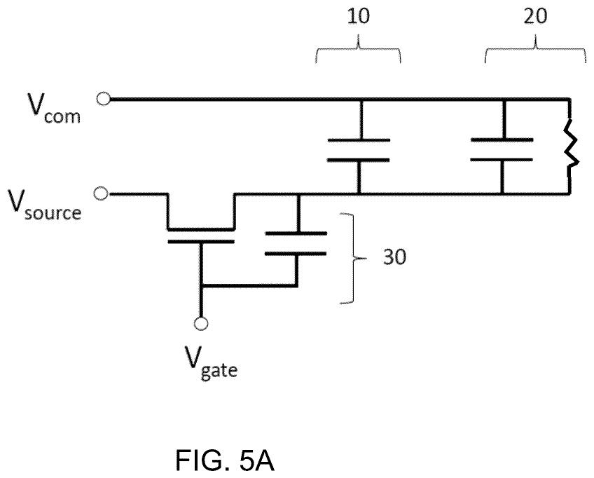

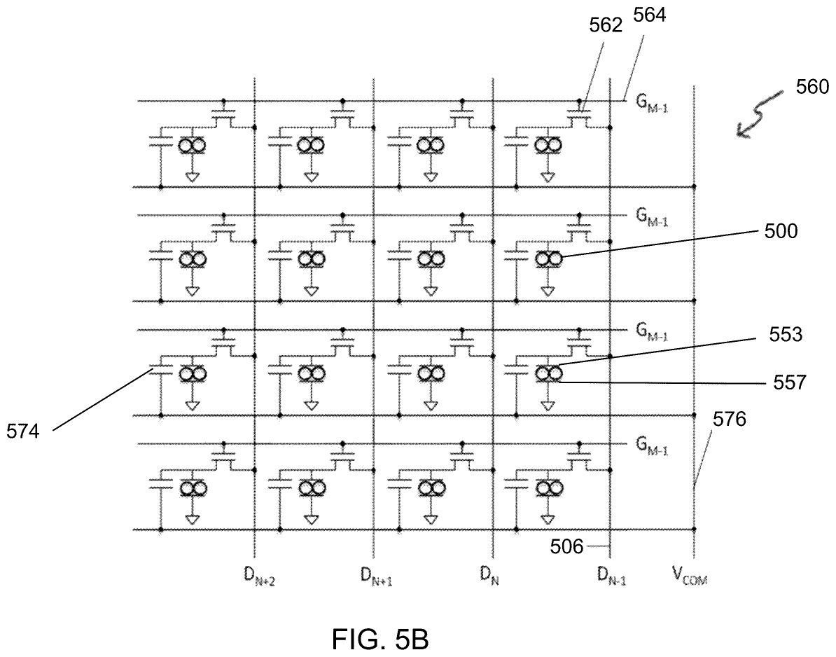

FIG. 5A depicts an exemplary equivalent circuit of a single pixel of an electro-optic display. As illustrated, the circuit includes a capacitor 10 formed between a pixel electrode and a capacitor electrode. The electrophoretic medium 20 is represented as a capacitor and a resistor in parallel. In some instances, direct or indirect coupling capacitance 30 between the gate electrode of the transistor associated with the pixel and the pixel electrode (usually referred to a as a “parasitic capacitance”) may create unwanted noise to the display. Usually, the parasitic capacitance 30 is much smaller than that of the storage capacitor 10, and when the pixel rows of a display is being selected or deselected, the parasitic capacitance 30 may result in a small negative offset voltage to the pixel electrode, also known as a “kickback voltage”, which is usually less than 2 volts.

In some embodiments, the TFT array forms an active matrix 560 for image driving, as shown in FIG. 5B. For example, each pixel electrode 553 (corresponding to 250 in FIG. 2) is coupled to a thin-film transistor 562 patterned into an array and connected to gate (row) driver lines 564 and source (column) driver lines 506, running at right angles to the gate drive lines 564. Also, typically, the common (top) light-transparent electrode 557 (corresponding to 210 in FIG. 2) has the form of a single continuous electrode while the other electrode or electrode layer is patterned into a matrix of pixel electrodes 553, each of which defines one pixel of the display. Between the pixel electrode 553 and the common electrode 557, an electro-optic medium 500 can be disposed. A source driver (not shown) is connected to the source driver lines 506 and provides source voltage to all TFTs 562 in a column that are to be addressed. A gate driver (not shown) is connected to the gate driver lines 564 to provide a bias voltage that will open (or close) the gates of each TFT 562 along the row. Each pixel of the active matrix 560 also includes a storage capacitor 574 as discussed above with respect to FIG. 5A. The storage capacitors 574 may be coupled to a common potential (V_{com}) line 576.

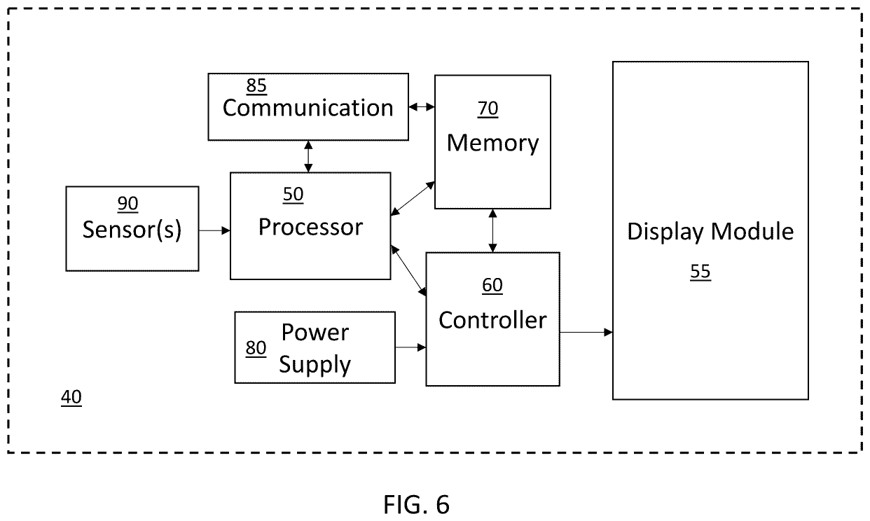

The active matrix 560 described with respect to FIG. 5B (i.e., including the electrophoretic medium 500 and the common light-transparent electrode 557) is typically covered by a protective sheet (e.g., integrated barrier) and sealed to create a display module 55, as shown in FIG. 6. Such a display module 55 becomes the focus of an electro-optic display 40. The electro-optic display 40 will typically include a processor 50, which is configured to coordinate the many functions relating to displaying content on the display module 55, and to transform “standard” images, such as sRGB images to a color regime that best duplicates the image on the display module 55. In some embodiments, the processor 50 performs the methods of the invention by determining which pixel electrodes should be updated during a partial update. Especially when dithering is being used for color production, the processor 50 can determine which areas of the dithered color are most at risk from blooming due to nearby pixel electrode updates. In other embodiments, some or all of the steps of the invention may be completed by the controller 60. As controller 60 architecture advances, more of the image processing can be embedded into the controller 60 such that an advanced controller can be incorporated into the same package as the display module 55 and pre-programmed with the tools needed to identify pixel electrodes that are at risk of blooming during a partial update. Advanced controllers for electro-optic displays are available from ULTRACHIP and NEXTRONIX.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus≤10% of the particular term and “substantially” and “significantly” will mean plus or minus>10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

Disclosed herein are crosslinkers and/or crosslinker blends capable of reacting with multiple functionalities in formulations containing two or more matrix materials, enabling formation of networks comprised of crosslinks generated independently from each of the matrix materials, as well as from networks generated from crosslinking of two or more of the matrix materials with each other (hybrid networks). The compositions disclosed herein enable improved adhesion to microcell substrate surfaces by a combination of improved cohesive strength of the matrix network, and also by adhesive strength of this network to the substrate surface. The compositions disclosed herein are particularly suited for blends of matrix polymeric materials.

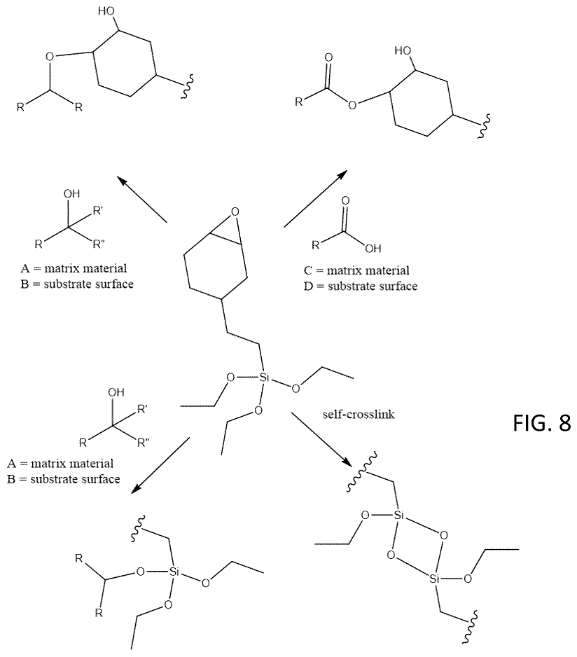

It was discovered that utilizing crosslinkers or crosslinker blends containing a plurality of unique functionality suitably matched to react with functionality present in matrix materials, as well as on the surface of substrate materials, improved adhesion to substrates. For example, FIG. 8 illustrates reaction pathways for an exemplary epoxy silane crosslinker that contains functionality capable of crosslinking with both the hydroxyl and carboxylic acid functionalities present in the matrix materials as well as those on the substrate. Furthermore, the silane functionality can self-crosslink, generating siloxane networks that also link substrate surfaces and matrix materials.

A particularly preferred embodiment of this disclosure is the formation of hybrid networks, wherein crosslinkers are chosen that react with functionality on two or more matrix materials. The resulting hybrid network throughout the matrix can combine properties based on each of the matrix materials. However, coating formulations may also employ crosslinkers that form multiple networks but only within each matrix material (non-hybridized).

### Experimental Procedure

Four sealant fluid formulations were tested in this experiment, which comprise a blend of RS1717 polyvinyl alcohol, Witcobond 386-03 polyurethane dispersion, and Raven 14 carbon black as the main components in the matrix formulation. Sealant fluid X41 contains polycarbodiimide crosslinker E-03A. Sealant fluid X60 contains polycarbodiimide VO2L2 crosslinker. To both of these base formulations was added Coat-O-Sil 1770 epoxysilane crosslinker in an amount equivalent to 3.0 weight % based on the weight of the dry sealant film. The fluids were mixed at 200 rpm for 60 minutes, followed by vacuum degassing overnight at 20 inHg.

Sealant fluid X61 is a blend of sealant fluid X41 with Coat-O-Sil 1770. Sealant fluid X62 is a blend of sealant fluid X60 with Coat-O-Sil 1770. The four fluids were independently bar coated onto 14 micron thick, plasma-treated microcell substrates, and were dried in a conveyer oven at 60 °C. Subsequently, adhesive CSL film of 4.5 gsm thickness was laminated to the surface of the dried sealant film. The films were cut into 1-inch-wide strips at a length of 10 inches. A 90° peel test measurement was carried out on an Instron 5540 series rig for at least 4 sample 1-inch-wide strips for each sealant fluid.

### Results and Discussion

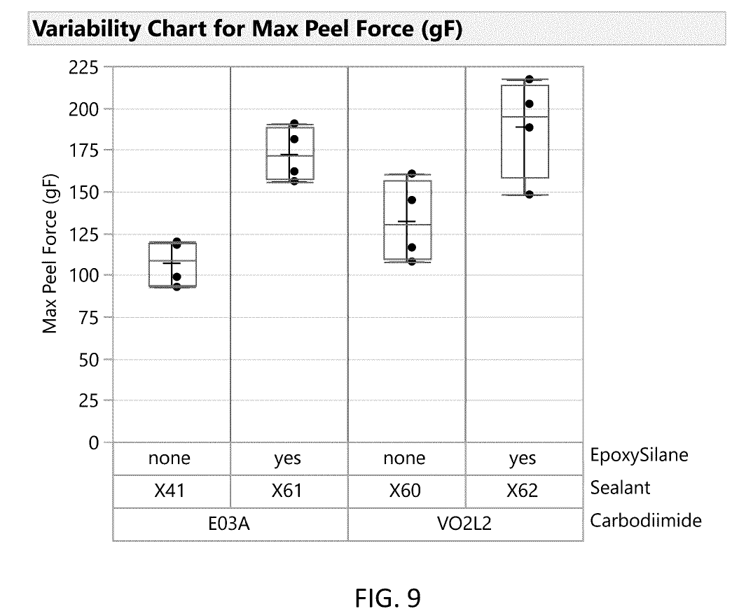

Microcell technology utilizes sealant material to adhere to microcell walls. Plasma treated microcell surface chemistry consists of polar functionality such as carboxylic acid and hydroxyl functionality. Sealant matrix material such as polyvinyl alcohol contains hydroxyl functionality. Polyurethane matrix material contains carboxylic acid functionality and optionally hydroxyl functionality. When epoxy silane crosslinkers were blended with carbodiimide crosslinkers, substantially improved adhesion to microcells was observed. FIG. 9 provides adhesion data for X41 and X60 sealant formulations, which differ in the specific carbodiimide crosslinker used while both containing polyvinyl alcohol, polyurethane, carbon black and carbodiimide crosslinker. When each sealant was blended with Coat-O-Sil 1770 epoxysilane crosslinker, a significant enhancement of adhesion strength to the microcell surface was observed for both inventive formulations.

### CONCLUSION

Adhesion of coating films to difficult substrates was improved with inventive formulations described herein by use of multiple crosslinking reactions that provided more complete crosslinking of matrix binders and substrate surfaces.

Improvements in other properties of adhesive, binder and sealant materials, such as electro-optical performance, may be impacted by improvements in crosslinking chemistry as a direct result of rheological control of the matrix network and the resulting impact on electrical properties (e.g., matrix-filler interaction and the impact on electronic and ionic conductivity).

What is claimed is:

1. A sealing composition comprising a heterofunctional crosslinker and a sealant fluid, wherein the sealant fluid comprises a matrix material comprising one or more poly(vinyl alcohol) polymers and an aqueous crosslinkable polyurethane dispersion having carboxylic acid functional groups; conductive particles; and a second crosslinker capable of reacting with a carboxylic functional group; and
wherein the heterofunctional crosslinker is capable of reacting with carboxylic acid functional group, a hydroxyl functional group, and a second heterofunctional crosslinker.

2. The sealing composition of claim 1, wherein the sealing composition comprises from about 1 to about 12 weight % of dry sealant fluid.

3. The sealing composition of claim 2, wherein the heterofunctional crosslinker is an epoxysilane crosslinker and the second crosslinker is a carbodiimide crosslinker.

4. The sealing composition of claim 3, wherein the epoxysilane crosslinker comprises a compound of formula X—(CH₂)ₙ—Si(R¹)(R²)(R³),
wherein X is an epoxycycloalkyl group, an epoxyalkyl group, or an epoxyalkoxyl group;
R¹, R², and R³ are independently an alkoxy, hydroxy, or alkyl group provided that at least one of R¹, R², and R³ is alkoxy or hydroxy; and n is an integer from 0-5.

5. The sealing composition of claim 3, wherein the carbodiimide crosslinker is a polycarbodiimide.

6. The sealing composition of claim 1, wherein the sealing composition comprises:
from about 1 to about 15 weight % of the heterofunctional crosslinker;
from about 20 to about 60 weight % of the one or more poly(vinyl alcohol) polymers;
from about 5 to about 50 weight % of the crosslinkable polyurethane dispersion;
from 0 to about 30 weight % of conductive particles; and
from about 1 to about 15 weight % of the second crosslinker.

7. The sealing composition of claim 6, wherein the heterofunctional crosslinker is an epoxysilane crosslinker and the second crosslinker is a carbodiimide crosslinker.

8. The sealing composition of claim 7, wherein the epoxysilane crosslinker comprises a compound of formula X—(CH₂)ₙ—Si(R¹)(R²)(R³),
wherein X is an epoxycycloalkyl group or an epoxyalkoxyl group; R¹, R², and R³ are independently an alkoxy, hydroxy, or alkyl group provided that at least one of R¹, R², and R³ is alkoxy or hydroxy; and n is an integer from 0-5.

9. The sealing composition of claim 7, wherein the carbodiimide crosslinker is a polycarbodiimide.

10. A sealing film prepared by crosslinking the sealing composition according to claim 1 to prepare a hybrid network, wherein the hybrid network comprises covalent bonds between heterofunctional crosslinkers and carboxylic acid functional groups of the matrix material, heterofunctional crosslinkers and hydroxyl functional groups of the matrix material, and covalent bonds between heterofunctional crosslinkers.

11. The sealing film of claim 10, wherein the hybrid network comprises covalent bonds between second crosslinkers and carboxylic acid functional groups of the matrix material.

12. The sealing film of claim 10, wherein the heterobifunctional crosslinker or the second crosslinker covalently binds the sealing film to a substrate comprising surface carboxylic acid and/or hydroxyl functional groups.

13. An electrophoretic media layer comprising a film of microcells comprising partition walls and top-openings, an electrophoretic fluid comprising charged pigment particles dispersed in a solvent filling the microcells, and a top-sealing layer that encloses the electrophoretic fluid within the microcells, wherein the top-sealing layer is formed by crosslinking the sealing composition according to claim 1.

14. The electrophoretic media layer of claim 13, wherein the film of microcells has surface carboxylic acid and hydroxyl functional groups and the top-sealing layer is covalently bound to the film of microcells.

15. An electro-optic device comprising
a conductive layer;
the electrophoretic media layer according to claim 13;
an adhesive layer, and
an electrode.

16. The electro-optic device of claim 15, wherein the film of microcells has surface carboxylic acid and hydroxyl functional groups and the top-sealing layer is covalently bound to the film of microcells.

17. A method of preparing a sealing film comprising crosslinking the sealing composition according to claim 1.

18. The method of claim 17, wherein crosslinking the sealing composition comprises heating the sealing composition to between 40 °C to 90 °C.

19. A method for preparing an electrophoretic media layer comprising enclosing a film of microcells comprising partition walls and top-openings with the sealing composition according to claim 1 and crosslinking the sealing composition, wherein an electrophoretic fluid comprising charged pigment particles dispersed in a solvent fills the microcells.
